(19) United States
(12) Patent Application Publication
(10) Pub. No.: US 2025/0165468 A1
(43) Pub. Date: May 22, 2025

(54) SYSTEMS AND METHODS FOR GRAPH TRAVERSAL FOR APPROXIMATE NEAREST NEIGHBOR SEARCH

(71) Applicant: Samsung Electronics Co., Ltd., Suwon-si (KR)

(72) Inventors: Yitu WANG, Santa Clara, CA (US); Andrew Zhenwen CHANG, Los Altos, CA (US)

(21) Appl. No.: 18/953,055

(22) Filed: Nov. 19, 2024

Related U.S. Application Data
(60) Provisional application No. 63/601,663, filed on Nov. 21, 2023.

(51) Int. Cl. G06F 16/2453; G06F 7/57; G06F 16/22; G06F 16/2455; G06F 16/2457

(52) U.S. Cl. CPC G06F 16/24534; G06F 7/57; G06F 16/2237; G06F 16/24561; G06F 16/24578

(57) ABSTRACT

A system and a method for approximate nearest neighbor search are disclosed. A query storage circuit stores query information related to at least one query from a host in a query property table. A generator and allocator circuit is configured to generate graph information using a batch of at least one vertex corresponding to the at least one queries from the query property table and to allocate the at least one queries to at least one logic unit (LU) based on the graph information. A search circuit has the at least one LU and is configured to compute at least one distance, using the graph information, between the at least one vertex and at least one candidate neighbor of the at least one vertex to generate at least one distance result. The query property table is modified based on the at least one distance result.

### CROSS-REFERENCE TO RELATED APPLICATION

This application claims the priority benefit under 35 U.S.C. § 119 (e) of U.S. Provisional Patent Application Ser. No. 63/601,663 filed on Nov. 21, 2023, the disclosure of which is incorporated by reference in its entirety as if fully set forth herein.

### TECHNICAL FIELD

The disclosure generally relates to machine learning. More particularly, the subject matter disclosed herein relates to approximate nearest neighbor search.

### BACKGROUND

Machine learning (ML) has emerged as a powerful tool in artificial intelligence (AI). Learning models in ML allow machines to respond to queries by sorting through a huge amount of data to select relevant information and to uncover relationships or connections among pieces of information. This process is typically based on a search for related information or items using some form of similarity. When the search is represented by a graph, the similarity between vertices in a graph is described as a distance based on a specified metric. Finding related information may be viewed as finding the nearest neighbors by traversing the graph.

### SUMMARY

Approximate nearest neighbor search (ANNS) is a technique to find the nearest points to a target point in a dataset. When these points represent vectors in a query-response system, ANNS attempts to find the most similar data points to a query point. Such a process has many applications in pattern recognition and machine learning. Existing techniques to perform ANNS include graph traversal, KD-tree and locally sensitive hashing (LSH). These techniques are computationally extensive and do not utilize resources such as storage devices efficiently.

To overcome these issues, systems and methods are described herein for a technique of performing an efficient approximate nearest neighbor search (ANNS). The technique aims at accelerating the graph traversal in the ANNS.

In an embodiment, a system and a method for ANNS are disclosed. A query storage circuit stores query information related to queries from a host in a query property table. A generator and allocator circuit is configured to generate graph information using a batch of vertices corresponding to the queries from the query property table and to allocate the queries to logic units (LUs) based on the graph information. A search circuit has the LUs and is configured to compute distances, using the graph information, between the vertices and candidate neighbors of the vertices in parallel to generate distance results. The query property table is modified based on the distance results.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2 is a diagram illustrating a dynamic scheduler according to an embodiment.

FIG. 3 is a diagram illustrating a format of data in the query property table according to an embodiment.

FIG. 4 is a diagram illustrating a generator buffer according to an embodiment.

FIG. 5 is a diagram illustrating an allocator circuit according to an embodiment.

FIG. 6 is a diagram illustrating a search circuit according to an embodiment.

FIG. 7 is a diagram illustrating a pipeline according to an embodiment.

FIG. 8 is a diagram illustrating a re-ordering operation according to an embodiment.

FIG. 9 is a diagram illustrating a multi-plane mapping according to an embodiment.

FIG. 10 is a flowchart illustrating a process for ANNS according to an embodiment.

FIG. 11 is a flowchart illustrating a process for dynamic scheduling according to an embodiment.

FIG. 12 is a diagram illustrating a computing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. Conversely, the plural forms are also intended to include the singular form as well, unless the context clearly indicates otherwise. For example, “neighbors” may include “at least one neighbor” or “one or more neighbors.” It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The term “circuit” as used herein may refer to a hardware component or a functionality embodied in a hardware component which may be formed by instructions in a memory and executed by a programmable processor. The term “scheduler” as used herein may refer to a “circuit” as above that performs operations on a platform according to some timing constraints in the ANNS accelerator. The term “multi-plane” as used herein may refer to “across at least one plane.” For example, “multi-plane instructions/operations” refers to “instructions/operations that are applied to at least one plane” in the device.

There are several problems in graph traversal to find nearest neighbors. One problem is computational cost. This computational cost includes high processing time and high costs of hardware components. The large number of components including storage devices to store data may be excessively high and lead to high power consumption and large areas. Another problem is wasted resources. Hardware components are not fully utilized.

Embodiments in the following describe a near data processing (NDP) solution for ANNS. Among all the ANNS algorithms, graph-traversal based ANNS may achieve the highest recall rate. In one embodiment, in-storage computing architectures support the ANNS kernels and leverage logic units (LU's) level parallelism inside solid-state drive (SSD) devices such as NAND flash chips. The processing model includes a two-level scheduling process to exploit spatial locality and temporal locality to efficiently utilize storage resources and achieve high-performance computing power. In addition, a speculative searching mechanism further accelerates the ANNS workload.

In one embodiment, the architecture includes a static scheduler, a dynamic scheduler, and a sorter. The static scheduler is configured to reorder an original graph having original vertices to generate a batch of vertices using a reordering procedure that is based on vertex degree in an ascending order. The procedure exploits spatial locality to improve processing time. The dynamic scheduler is configured to compute distances in the batch of vertices as part of the search of closest neighbors of vertices. In one embodiment, the dynamic scheduler includes a query storage circuit, a generator and allocator circuit, and a search circuit. The query storage circuit stores query information related to queries from a host in a query property table. The query information is represented in a format that is suitable for in-storage parallel computing. The generator and allocator circuit is configured to generate graph information using the batch of vertices corresponding to the queries from the query property table and to allocate the queries to logic units (LUs) based on the graph information. The search circuit includes the LUs and is configured to compute the distances, using the graph information, between the vertices and candidate neighbors of the vertices in parallel to generate distance results. The process exploits temporal locality in a batch of queries to shorten the search time. The query property table is modified based on the distance results. The sorter is a circuit configured to sort the distances in the distance results and send N candidate neighbors corresponding to N highest ranking distances to the host.

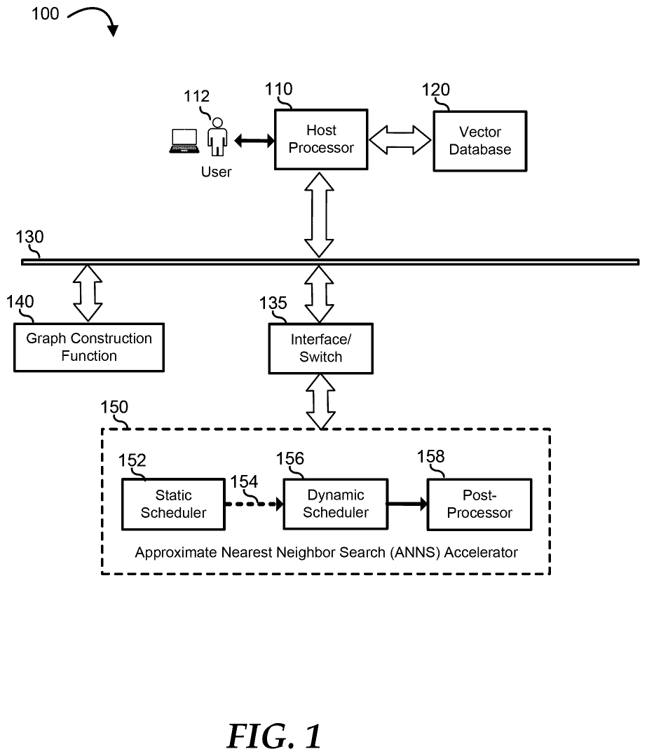

FIG. 1 is a block diagram illustrating a system 100 according to an embodiment. The system 100 includes a host processor 110, a vector database 120, a bus or communication link 130, an interface/switch 135, a graph construction function 140, and an ANNS accelerator 150. The system 100 may include more or less than the above components.

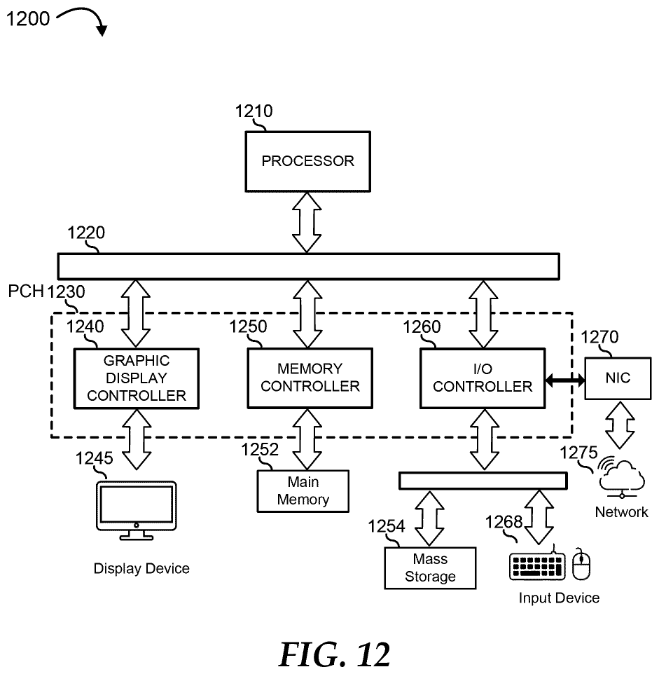

The host processor 110 may be any processor that can perform communication and control functions to other devices. It may be a central processing unit (CPU), a microprocessor, a microcontroller, a digital signal processor, a graphics processing unit (GPU), a special-purpose processor, or any processor that can execute programs in a memory. The host processor 110 may be a single processor, a minimally populated system including a programmable processor and memories, or a system such as system 1200 shown in FIG. 12. Its function is to control and communicate with the vector database 120, the graph construction function 140, and the ANNS accelerator 150. It may read from and write to the vector database 120, send commands or instructions to the ANNS accelerator 150, read status or reports from the ANNS accelerator 150, and interface with other applications (not shown) that uses ANNS such as a large language model (LLM) in ML, a query and response system, a pattern recognition application, an image analysis/computer vision application, and a medical diagnosis application.

The vector database 120 is a database that stores data in a form of vectors. A vector is a data structure that contains values in several fields. These values may represent characteristic attributes of an item. In ANNS applications, the vector database 120 may store information or data that may be retrieved for comparison with a query vector.

The bus or communication link 130 is any interface structure that allows the host processor 110 to communicate with the graph construction function 140, the ANNS accelerator 150, and any other devices that are linked or connected to the bus or communication link 130. In one embodiment, the bus or communication link 130 may include a high-speed serial computer expansion bus.

The interface/switch 135 may provide an interconnect to various devices and systems. It may maintain cache coherency between a processor memory spece and memory on attached devices to allow resource sharing. The interface/switch 135 may allow several devices or systems to offload data or computations to the ANNS accelerator 150. For example, an LLM or a query-response system may offload the computations of similarities between queries vectors and knowledge vectors from the vector database 120 via the interface/switch 135. Other operations may also benefit from this architecture such as sorting, top-K selection, neighbor search, correlation, matching, classification, fine-tuning, etc. The interface/switch 135 may also allow data path switching to route data from one device to another. For example, specially designed circuits in field programmable gate array (FPGA) may be used to perform special functions such as correlation, sorting.

The graph construction function 140 may be a functionality implemented by hardware or software or a combination of both. It constructs a graph from the information retrieved from the vector database 120 or the host processor 110. It may store information that identifies an item and the item's neighbors. It may be used by the ANNS accelerator 150 to format data for processing or for reporting to the host processor 110.

The ANNS accelerator 150 accelerates the ANNS using several techniques including fine-grained level parallelism, in-place acceleration at the logic unit (LU) level, exploitation of spatial locality and temporal locality in graph traversal, fetch and prefetch pipelining, localized parallelism at the storage device level, and allocation of graph functions to multiple LU's. In one embodiment, the computations are further enhanced by modifying existing structure of smart solid-state drives (SSDs) to include specially designed storage and computational elements. In addition, the structure of the SSDs with specially designed computational elements that support pipelining and parallelism helps offloading and distributing computations to a large number of computational elements. The internal bus structure allows efficient data transfers among storage and computational elements, resulting in reduced external data transfers and power consumption.

In one embodiment, the ANNS accelerator 150 includes a static scheduler 152, a dynamic scheduler 156, and a post-processor 158. The ANNS accelerator 150 may include more or less than the above elements. Any one of the static scheduler 152, the dynamic scheduler 156, and the post-processor 158 may correspond to a functionality that can be implemented by software, hardware, or a combination of both.

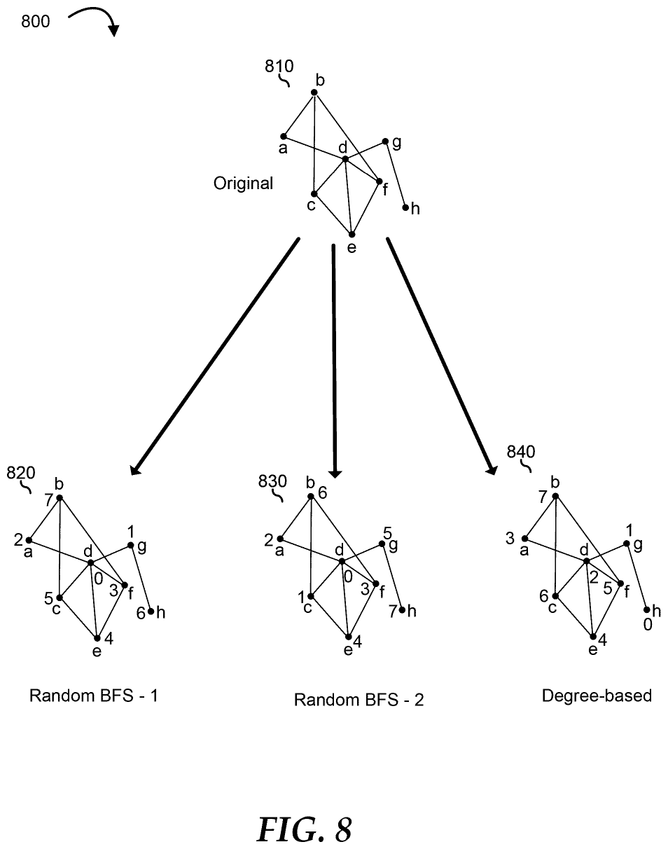

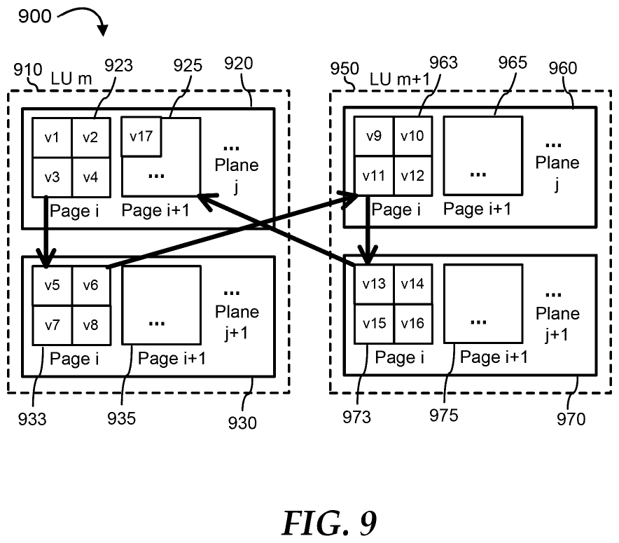

The static scheduler 152 improves data accesses to buffers that store data by reordering the vertices in the graph and remapping the re-ordered vertices to the storage device. In one embodiment, the storage device is the SSDs. The re-mapping exploits spatial locality by storing neighboring vertices in the same page in the SSD with the restrictions of multi-plane operations of the SSD. Due to the huge amount of data including the vectors in the vector database 120, it may take the static scheduler 152 a long time to perform the re-ordering and re-mapping. Therefore, in one embodiment, the static scheduler 152 operates in an off-line manner, i.e., not in real-time in conjunction with the dynamic scheduler 156 and the post-processor 158. If the amount of data is reasonable or if the SSD's are very fast, the process may take much less time and the static scheduler 152 may operate in an on-line manner, i.e., in conjunction with the dynamic scheduler 156 in real-time. Once the re-ordering and the re-mapping operations are completed, the results may be forwarded to the dynamic scheduler 156 via a path 154. The path 154 is shown as a dashed line to indicate that it may be off-line or on-line. The static scheduler 152 will be further described in FIGS. 8 and 9.

The dynamic scheduler 156 performs the ANNS with efficiency in terms of storage utilization and processing time. It generates distances between vertices representing queries and their corresponding neighbors in the re-ordered graph provided by the static scheduler 152. The distances represent the similarity between queries and their neighbors. The dynamic scheduler 156 may work on an original graph without the vertices being re-ordered by the static scheduler 152.

The post-processor 158 processes the results generated by the dynamic scheduler 156 and prepares the results for use with the application. In one embodiment, the post-processor 158 includes a sorter that sorts the distances and selects N neighbors that have the shortest distances to the vertices. In other words, the post-processor 158 selects N neighbors that have distances ranking at the top of the sorted distances. The sorter in the post-processor 158 executes the bitonic sorting kernel and returns the top N neighbors if each query to the host. In one embodiment, the post processor 158 is realized by an applications specific integrated circuit (ASIC), field programmable gate array (FPGA), or specially designed circuits. The post-processor 158 then sends this list of N nearest neighbors to the host processor 110 for further processing according to the underlying application. The post-processor 158 may perform other operations to enhance the results. This may include fine-tuning the results by applying contextual information, filtering the data, etc. The post processor 158 may be connected to the interface/switch 135 to perform special functions in support of other devices.

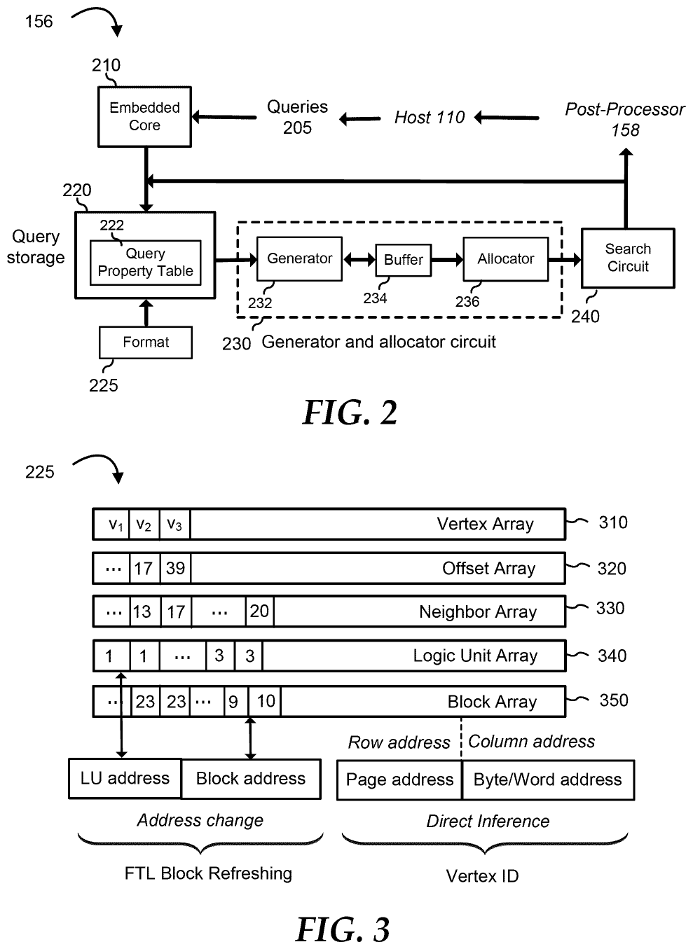

FIG. 2 is a diagram illustrating the dynamic scheduler 156 according to an embodiment. The dynamic scheduler 156 includes an embedded core 210, a query storage circuit 220, a generator and allocator circuit 230, and a search circuit 240. The dynamic scheduler 156 may include more or less than the above elements. In addition, any of these elements may be implemented by hardware, software, or a combination of both. Furthermore, parts of the dynamic scheduler 156 may be implemented as a smart SSD with integrated control and computing elements. The dynamic scheduler 156 aims at computing the distances between vertices and their neighbors with efficiency in storage space and processing time. It performs an iterative procedure in which a new vertex is selected at each iteration.

The embedded core 210 performs logic and arithmetic operations on queries 205 sent from the host processor 110 to transform the queries 205 into a form suitable for processing. It may also perform control functions for the SSD that contains these components. In one embodiment, the embedded core 210 assigns initial entry vertex for each query.

The query storage circuit 220 stores data or query information related to the queries 205 from the host processor 110 in a query property table 222. It may also change, modify, or update the query property table 222 iteratively based on the result of the search circuit 240. The query property table 222 stores the property of each query, such as the current searching status, the query identifier (ID), the ID of entry vertex in an iteration, the feature vectors of the query, the result list from the search. The result list of a query may include the query ID, the index or identifiers of the query's candidate neighbors, and the values of the distances between the query and the candidates. The information or data are arranged or organized according to a predefined format 225.

The format 225 provides a way to store graph data with useful information to facilitate data access and processing. FIG. 3 show the organization of the format 225.

The generator and allocator circuit 230 is configured to generate graph information using a batch of vertices corresponding to the queries 205 from the query property table 222 and to allocate the queries to logic units (LUs) based on the graph information. The batch of vertices is processed by the embedded core 210 to prepare for processing. The batch of vertices may be any batch of vertices representing the queries 205. When the vertices are re-ordered and re-mapped by the static scheduler 152, this batch of vertices may be obtained from the results generated by the static scheduler 152, either directly from the static scheduler 152 in an on-line configuration or from the host processor 110 when the static scheduler 152 operates in an off-line manner as discussed above. When the static scheduler 152 is used, the batch of vertices is obtained by reordering an original graph having original vertices using a reordering procedure that is based on vertex degree in an ascending order as will be discussed in FIG. 8. The graph information may include at least one of a query identifier, a query vector, a neighbor identifier corresponding to the query identifier, a logic unit identifier associated with the query identifier, and a pre-fetched query and pre-fetched logic unit.

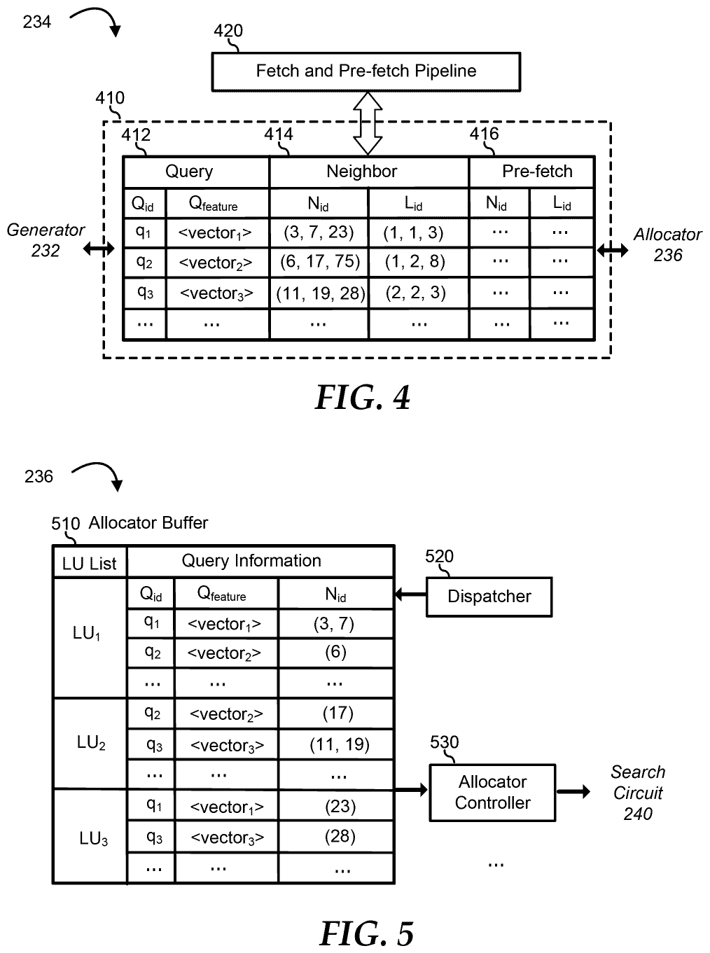

The generator and allocator circuit 230 includes a generator circuit 232, a generator buffer 234, and an allocator circuit 236. The generator and allocator circuit 230 may include more or less than the above elements. The generator circuit 232 generates the graph information in a fetch pipeline. The generator buffer 234 is configured to store the graph information. The fetch pipeline allows overlapping reading and fetching operations to provide fast processing time. The generator buffer and the pipeline will be further described in FIG. 4. The allocator circuit 236 is configured to allocate the queries to the LU's in the search circuit 240.

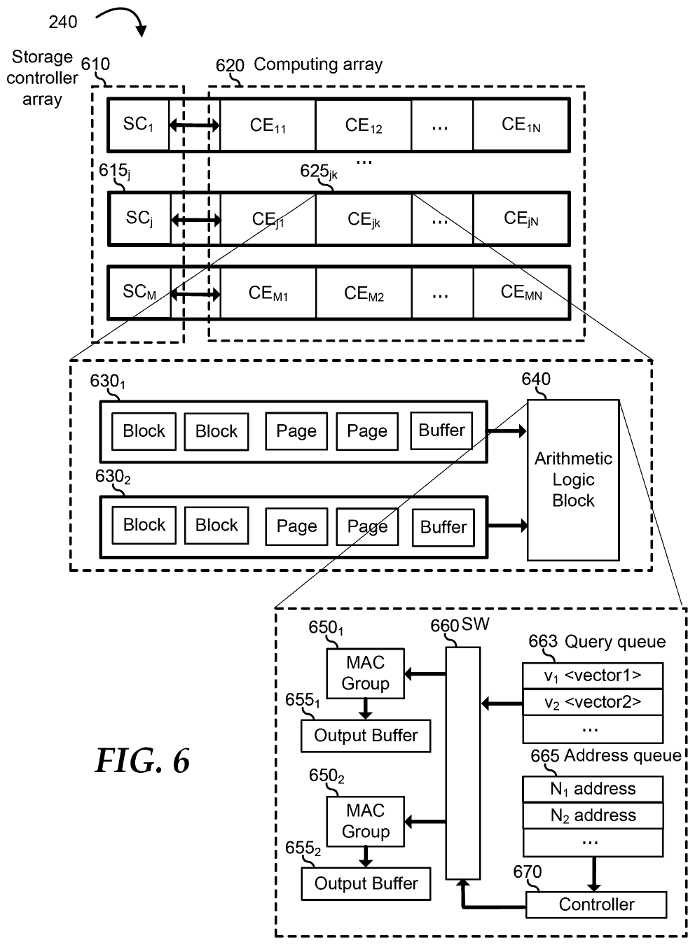

The search circuit 240 has the LUs and is configured to compute distances, using the graph information, between the vertices and candidate neighbors of the vertices in parallel to generate distance results. The search circuit 240 will be further described in FIG. 6.

FIG. 3 is a diagram illustrating the format 225 of data in the query property table according to an embodiment. The format 225 includes at least one of a vertex array 310, an offset array 320, a neighbor array 330, a logic unit array 340, and a block array 350. The format 225 may include more or less than the above arrays.

The format 225 extends the format definition of the compressed sparse row (CSR) format to further include vertex placement information. The standard CSR format includes the vertex array 310, the offset array 320, and the neighbor array 330. In one embodiment, the vertex array 310 stores the vertex ID, for example, v₁, v₂, v₃, etc. Using the IDs to reference the vertices provides an efficient way to manipulate and process the vertices. The offset array 320 provides the offset to the location of the neighbor in the neighbor array or field 330. The neighbor array 330 provides the IDs of the neighbors of the vertex. The format 225 extends the CSR format to further include the logic unit array 340, and the block array 350. The logic unit array 340 stores the physical LU allocation of the vertices. The block array 350 stores each vertex's relative block allocation within an LU. Both arrays may be indexed by the vertex IDs or the neighbor IDs and updated by Flash Translation layer (FTL) when data refreshing occurs. The SSDs used in the ANNS accelerator 150 uses block-level refreshing. FIG. 3 further shows how FTL updates the logic unit array 340 and the block array 350. The logic unit array 340 and the block array 350 are managed in a similar manner that the FTL manages the mapping table in the SSDs to guarantee coherency and consistency of the data. The page/column address may be directly inferred from the logical index of a vertex since it is not affected by the block-level refreshing.

FIG. 3 further shows an example on how the allocator circuit 236 indexes the neighbors of v₂ in the arrays. The arrows illustrate the indexing traces. Specifically, the ID (i.e., 2) of v₂ points to its first neighbor v₁₃ with offset 17. The allocator circuit 236 uses the offset value as the pointer to access the neighbor list of v₂ (the length of the neighbor list is the difference between v₃'s offset and v₂'s offset). Then, using the neighbor IDs, the allocator circuit 236 can find the neighbors' corresponding LU and block IDs. The neighbor IDs (also the vertex IDs) further indicate the page and column addresses so the physical address of each neighbor may be generated.

FIG. 4 is a diagram illustrating the generator buffer 234 according to an embodiment. The generator buffer 234 includes a field buffer 410 and a fetch and pre-fetch pipeline 420. The generator buffer 234 may include more or less than the above components.

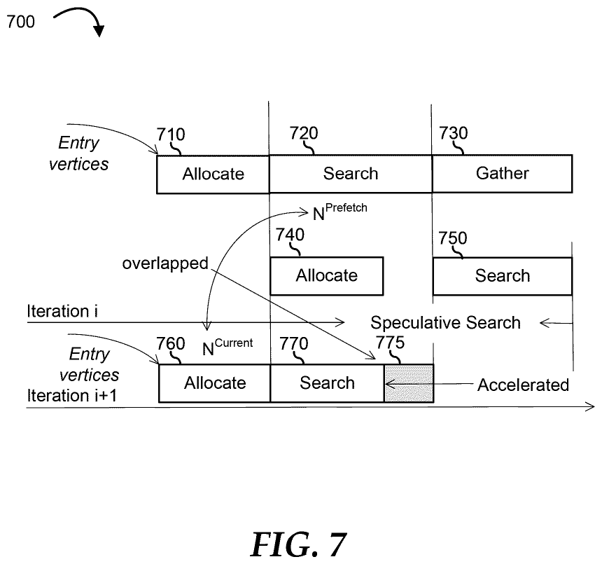

The field buffer 410 includes a query buffer 412, a neighbor buffer 414, and a pre-fetch buffer 416. The fetch and pre-fetch pipeline 420 has internal pipelines (not shown) including query read stage, offset fetch stage, neighbor stage, logic unit fetch stage, and pre-fetch stage. These stage pipelines read and fetch data in an overlapping manner to improved throughput. The query buffer 412 stores a batch of queries. Then the query read stage reads the IDs of the entry vertices in the current search iteration and sends them to the offset fetch stage. The three stages: offset stage, neighbor fetch stage, and the logic unit fetch stage form a three-stage pipeline to fetch the offset values, the neighbor IDs, and the logic unit IDs of the neighbors of the entry vertices, respectively, following the indexing process as described in the format 225. Then the neighbor fetch stage writes the neighbor IDs into the N_{id} field of the neighbor buffer 414 while the logic unit fetch stage writes the corresponding logic unit IDs into the L_{id} field of the neighbor buffer 414. The pre-fetch buffer 416 stores the prefetched neighbors to be used in the speculative searching as shown in FIG. 7.

FIG. 5 is a diagram illustrating the allocator circuit 236 according to an embodiment. The allocator circuit 236 includes an allocation buffer 510, a dispatcher 520, and an allocator controller 530. The circuit 236 may include more or less than the above components.

Based on the L_{id} in the neighbor buffer 414, the dispatcher 520 gathers the neighbor with the same LU IDs and the corresponding queries to the same allocation buffer 510 which is indexed by, or horizontally partitioned according to, LU IDs. In other words, the dispatcher 520 is configured to format, rearrange, or reorganize the graph information from the generator buffer 234 to generate formatted, rearranged, or reorganized graph information. The allocator buffer 510 is configured to store the formatted, rearranged, or reorganized graph information indexed by the logic units. For example, LU₁ is assigned or allocated to query q₁ which has neighbors 3 and 7 and query q₂ which has neighbor 6; LU₃ is assigned or allocated to query q₁ which has neighbor 23 and query q₃ which has neighbor 28. The allocator controller 250 is configured to generate allocator data including addresses of neighbors and corresponding content to the LU's. The allocator controller 250 sends the data and the physical addresses to the corresponding LU-level accelerator through a storage array 610 in the search circuit 240.

FIG. 6 is a diagram illustrating the search circuit 240 according to an embodiment. The search circuit 240 includes a storage controller array 610 and a computing array 620. The search circuit 240 may include more or less than the above components. Embodiments include the following features: (1) developing LU-level accelerators based on the existing multi-LU operations to explore the internal operation parallelism of SSD devices (e.g., NAND flash chips), and (2) including a dynamic scheduling mechanism to allocate the queries, whose target vertices are in the same LU, in one batch to the same LU based on the format 225, to improve processing time.

The storage controller array 610 is configured to store the allocator data in the format 225 as discussed above. The format 225 includes at least one of a vertex array, an offset array, a neighbor array, a logic unit array, and a block array. The storage controller array 610 includes M storage controllers (SC) from SC₁ to SC_{M} such as SCⱼ 615ⱼ. The computing array 620 has multiple LU's and is organized to correspond to the storage controller array 610. It has M rows of computing elements (CEs) or accelerators, each row has N CEs. The M rows of the CEs are linked to the M SC's, respectively The SC sends a LU-level instructions to the computing array 620 to make the LU-level accelerators to process the queries in parallel. Each of the CEs may contain multiple planes. Each CE (e.g., CE 625ⱼₖ) may have two logic unit-level accelerators. For clarity, only one accelerator is shown. Each accelerator may include two planes 630₁ and 630₂ and an arithmetic logic block 640. Each plane may include two blocks, two pages, one buffer, and a decoder (not shown). The arithmetic logic block 640 may perform multiply-and-accumulate and other logic to compute the distances. In one embodiment, the arithmetic logic block 640 includes two multiplier-accumulator (MAC) groups 650₁ and 650₂, two output buffers 655₁ and 655₂, a switch 660, a query queue 663, an address queue 665, and a controller 670. The query queue 663 buffers the feature vectors of queries that are allocated to this LU by the allocator 236. The address queue 665 buffers the addresses for the neighbors of each query in the current search iteration. The controller 670 sends multi-plane instructions to read vertices from different planes and enables the two MAC groups to operate in parallel. The queries are sent to the corresponding MAC group via the switch 660. Each of the MAC groups computes the distance using the multiply and accumulate operations. The result is stored in the output buffers 655₁ and 655₂ The distance may be computed using any suitable distance algorithms such as Euclidean distance, angular distance, inner product distance, or cosine similarity measure. The MAC groups 650₁ and 650₂ may be modified to accommodate other distance computations. For embedded vectors, a cosine similarity measure may be used. The computations are performed iteratively. The computed distances may be stored in a buffer (e.g., the output buffers 655₁ and 655₂) to be sent out to the post-processor 158.

The multi-LU search operation may be based on the multi-LU read operation in the SSD. For example, the following is a workflow of multi-LU read:
1) <Read page> issued to LU₀
2) <Read page> issued to LU₁
3) <Read Status Enhanced> selects LU₀'s page buffer
4) <Change Read Column> issued to LU₀'s page buffer
5) Data transferred from LU₀
6) <Read Status Enhanced> selects LU₁'s page buffer
7) <Change Read Column> issued to LU₁'s page buffer
8) Data transferred from LU₁.

The multi-LU search is realized by changing the <Read Page> instruction to the specialized <Search Page> instructions and “page buffer” to the “output buffer” as follows:
1) <Search Page > issued to LU₀
2) <Search Page > issued to LU₁
3) <Read Status Enhanced> selects LU₀'s output buffer
4) <Change Read Column> issued to LU₀'s output buffer
5) Data transferred from LU₀
6) <Read Status Enhanced> selects LU₁'s output buffer
7) <Change Read Column> issued to LU₁'s output buffer
8) Data transferred from LU₁.

The instructions may include several fields including distance, row address, and dimension and precision of the feature vectors. There may be a page location bit to show the locality of the buffer, for example, the bit may indicate that there weill be two or more queries' candidates located on the selected page.

The search circuit 240 computes the distances efficiently by exploiting the temporal locality existing in a batch of queries. The basic concept is based on the observation that for a batch of queries, there is always some amount of overlapping because queries are often related. When operating iteratively, if a distance has been already computed in a previous iteration due to the overlap, it is not computed again in the current iteration. This will help shorten the computational time and increase the throughput. To determine if there is an overlap, a comparison of the IDs of the prefetched neighbors and the current neighbors may be made. If the IDs are the same, no computation of distance is performed. Alternatively, the computation of distances will be performed if the current distances are different from previous distances in a previous iteration.

FIG. 7 is a diagram illustrating a pipeline 700 according to an embodiment. The search circuit 240 performs the search using a speculative search scheme which is based on the pipeline 700 of three sequential stages: an allocate stage 710, a search stage 720, and a gather stage 730.

The allocate stage 710 of the next search iteration usually requires the updated results of the gather stage 730 of iteration[i] to determine the entry vertices in iteration[i+1]. The decoupling of the three stages allows an overlap of latency of the allocate stage 710 and search stage 720. The speculative search scheme is based on the observation that the second-order neighbors of the entry vertex in the current iteration are the potential candidates to access in the next search iteration. Recall that a second-order neighbor of a vertex is the neighbor of the neighbors of the vertex. Thus, the second-order neighbors are highly likely to be accessed in the next iteration. Accordingly, in the search iteration, when the allocate stage 740 is done, it is possible to get the neighbor IDs (N_{id}'s) of each entry vertex in the current iteration. When the search stage 750 of this iteration begins, the speculative searching for the next iteration (iteration[i+1]) may be started by launching the speculative allocate stage 760 in iteration[i]. The prefetch unit fetches the neighbors of each entry vertex in iteration[i] and generates the corresponding IDs of some second-order neighbors of each vertex (N^{Prefetch}_{id}'s) for each entry vertex in iteration[i]. Since the number of second-order neighbors is usually larger than that of the first-order neighbors of each entry vertex, the prefetch unit selects the second-order neighbors that have more connections with the first-order neighbors. The N^{Prefetch}_{id}'s are stored in the prefetch buffer 416 (shown in FIG. 4). When the search stage of iteration[i] ends and the gather stage of iteration[i] starts, the speculative search stage launches to compute the distances between the queries with their prefetched neighbors. Then, for a query, if there is an overlap between its N_{id}'s in iteration[i+1] and N^{Prefetch}_{id}'s in iteration[i] (or their intersection is non-zero), the corresponding speculative search results can be used. In this way, the search stage 770 of iteration[i+1] can be accelerated as shown with the time period 775. Note that if the speculative allocate stage does not complete when the no-speculative search stage ends in iteration[i] the speculative allocate stage will be forcibly terminated. Hence, the latency of the speculative searching may be entirely overlapped.

FIG. 8 is a diagram illustrating a re-ordering operation 800 according to an embodiment. The re-ordering operation 800 is performed in the static scheduling 152. This operation exploits the spatial locality and is based on the observation that if vertices with lower degrees (having less neighbors) are re-ordered first, their neighbors with higher degrees (having more neighbors) may still remain unnumbered and be easily to be closely labeled, resulting in a small vertex bandwidth β. The bandwidth β is a metric that measures how the neighbors are placed. A small value of β indicates the neighbors of each vertex are stored physically close to each other. In addition, the process is further enhanced by placing the higher degrees vertices closer to their already renumbered neighbors.

FIG. 8 shows an example that illustrates this process. An original graph 810 may be re-ordered to a re-ordered graph 820, a re-ordered graph 830, and a re-ordered graph 840. The graph 820 is the result of a first random breadth first search (BFS) and has a bandwidth β=5.875. The graph 830 is the result of a second BFS and has a bandwidth β=5.125. The graph 840 is the result of the degree-based static scheduling and has a bandwidth β=3.625.

In this example, vₕ is first selected as the root vertex because it has the minimal degree (=1). Then, the BFS traversal would find v_{g}, and it is renumbered to v₁. After renumbering v_{d} to v₂, its neighbors are re-ordered according to their degree ascending order. In this example, the degrees of vₐ, v_{c}, vₑ, v_{f}, and v_{g}, or 3, 4, 3, 3, and 1, respectively. Because v_{g} has been renumbered, the process further renumbers vₐ as v₃, vₑ as v₄, v₅ as v₅, and vₑ as v₆. The re-ordering process will continue until all vertices are renumbered.

FIG. 9 is a diagram illustrating a multi-plane mapping 900 according to an embodiment. The mapping 900 exploits the parallelism of multi-plane operations in smart SSDs. The mapping 900 involves a LU[m] 910 and a LU[m+1] 950. The LU[m] 910 includes a plane[j] 920 and plane[j+1] 930. The plane[j] 920 has page[i] 923 and page[i+1] 925. The plane[j+1] 930 has a page[i] 933 and page[i+1] 935. The LU[m] 950 includes a plane[j] 960 and plane[j+1] 970. The plane[j] 960 has page[i] 963 and page[i+1] 965. The plane[j+1] 970 has a page[i] 973 and page[i+1] 975.

The re-ordered vertices should be mapped under the restrictions of multi-plane addressing. There are two restrictions applied to the multi-plane address when executing a multi-plane command sequence on a particular LU. First, the plane address bits are distinct from any other multi-plane operations in the multi-plane command sequence. Second, the page/LU address is the same as any other multi-plane operations in the multi-plane command sequence. The mapping strategy is that the process first maps the re-ordered vertices in one page of a plane to one LU, e.g., page[i] in plane[j] to maximize the data locality in one page. Then the process chooses the same page[i] in another plane[j+1] in the same LU. This is shown as an arrow going from page[i] 923 to page[i] 933. Next, the process iteratively performs the mapping with the aforementioned process on different LU's. This is shown as arrows from page[i] 933 to page[i] 963 and page[i] 963 to page[i] 973. If all LU's have been selected, the process goes back to the first LU and selected a different page number for the subsequent vertices. This is shown as an arrow from page[i] 973 to page[i+1] 925.

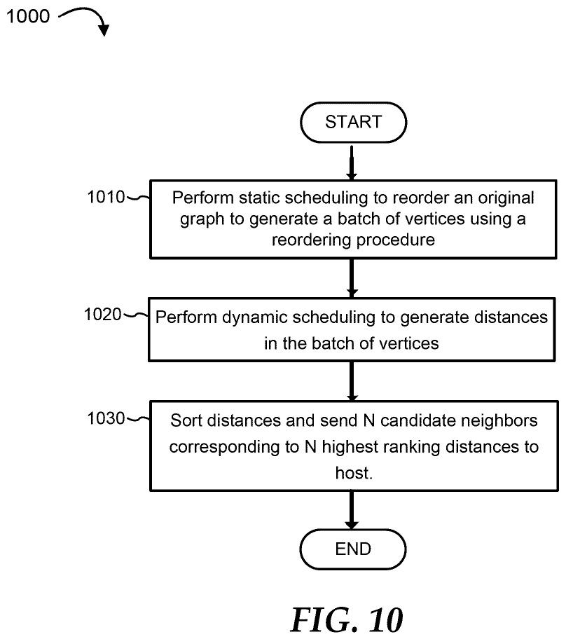

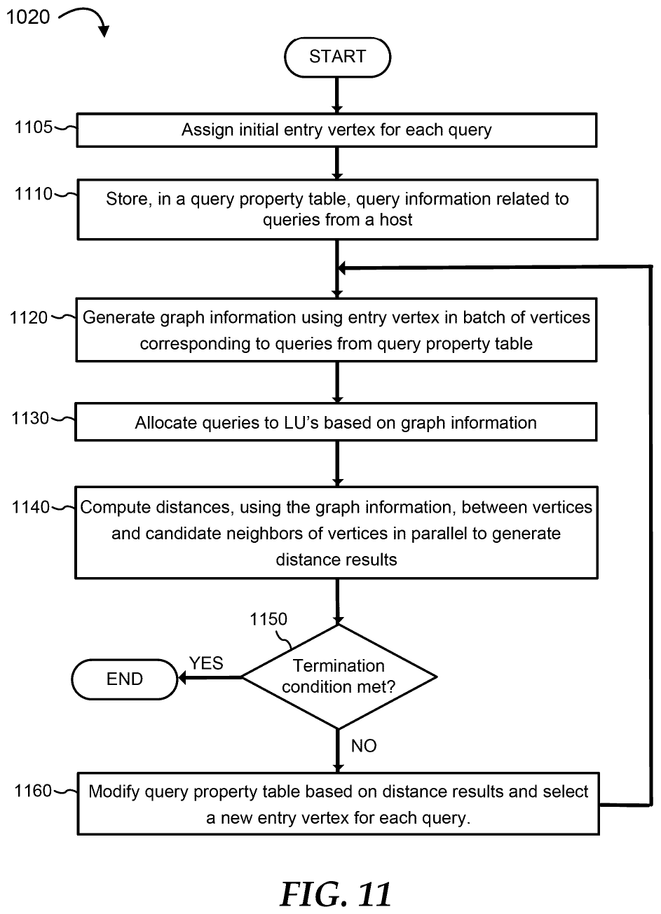

FIG. 10 is a flowchart illustrating a process 100 for ANNS according to an embodiment. Upon START, the process 1000 performs a static scheduling to reorder an original graph to generate a batch of vertices using a reordering procedure (Block 1010). This operation may be optional and may be performed off-line or on-line depending on the application. Next, the process 1000 performs a dynamic scheduling to generate distances in the batch of vertices (Block 1020). This operation will be further described in FIG. 11. Then, the process 1000 sorts the distances and sends N candidate neighbors corresponding to N highest ranking distances to the host processor (Block 1030). The process 1000 is then terminated.

FIG. 11 is a flowchart illustrating a process 1100 for dynamic scheduling according to an embodiment. Upon START, the process 1100 assigns an initial entry vertex for each query (Block 1105). Then, the process 1100 stores, in a query property table, query information related to queries from a host (Block 1110). The queries may be issued from the host, may be retrieved from a vector database, or may be the result of running an application.

Next, the process 1100 generates graph information using the vertex entry in a batch of vertices corresponding to queries from the query property table (Block 1120). The graph information may include query identifiers, query vectors, neighbor identifiers corresponding to the query identifiers, logic units identifiers associated with the query identifiers, and pre-fetched queries and logic units. Then, the process 1100 allocates queries to logic units (LUs) based on the graph information (Block 1130). The allocation aims at distributing the work load on a device (e.g., the SSDs) having multiple logic units to perform the operations in parallel.

Next, the process 1100 computes distances, using the graph information, between vertices and candidate neighbors of vertices in parallel to generate distance results (Block 1140). The computation is iterative and exploits the temporal locality in a batch of queries. Then, the process 1100 determines if the termination condition has been met (Block 1150). This termination condition may depend on the application. It may be whether all query vertices have been processed. Or it may be whether a performance criterion has been fulfilled such as a desirable bandwidth has been reached. If not (NO branch at block 1150), the process 1100 modifies, changes, or updates query property table based on distance results and selects a new entry vertex for each query (Block 1160) and returns to block 1120 to continue the iterative process with a modified or updated query property table. Otherwise, if the termination condition has been met (YES branch at block 1150), the process 1100 is terminated.

FIG. 12 is a diagram illustrating a computing or processing system 1200 according to an embodiment. The computing system 1200 may be a host in a system on which the ANNS accelerator 150 operates, or it may be the host processor 110. It includes a central processing unit (CPU) or a processor 1210, a platform controller hub (PCH) 1230, and a bus 1220. The PCH 1230 may include a graphic display controller (GDC) 1240, a memory controller 1250, and an input/output (I/O) controller 1260. The processing system 1200 may include more or less than the above components. In addition, a component may be integrated into another component. As shown in FIG. 12, all the controllers 1240, 1250, and 1260 are integrated in the PCH 1230. The integration may be partial and/or overlapped. For example, the GDC 1240 may be integrated into the processor 1210, the I/O controller 1260 and the memory controller 1250 may be integrated into one single controller, etc.

The processor 1210 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 1210 may have simultaneous multithreading feature to further exploit the parallelism due to multiple threads across the multiple cores. In addition, the processor 1210 may have internal caches at multiple levels.

The bus 1220 may be any suitable bus connecting the processor 1210 to other devices, including the PCH 1230. For example, the bus 1220 may be a Direct Media Interface (DMI).

The PCH 1230 in a highly integrated chipset that includes many functionalities to provide interface to several devices such as memory devices, input/output devices, storage devices, network devices, etc.

The I/O controller 1260 controls input devices 1268 (e.g., stylus, keyboard, and mouse, microphone, image sensor) and output devices (e.g., audio devices, speaker, scanner, printer), and a mass storage 1254. The mass storage 1254 may also include CD-ROM, hard disk, and SSDs. The SSDs may be used with the vector database 120 as described above. It also has a network interface card (NIC) 1270 which provides interface to a network and wireless medium 1275.

The memory controller 1250 controls memory devices such as a main memory 1252. The main memory 1252 includes random access memory (RAM) and/or the read-only memory (ROM) and other types of memory such as the cache memory or an SSD. The main memory 1252 may store instructions or programs, loaded from a mass storage device, that, when executed by the processor 1210, cause the processor 1210 to perform operations as described above. It may also store data used in the operations. The ROM may include instructions, programs, constants, or data that are maintained whether it is powered or not. The instructions or programs may correspond to the functionalities described above, such as the static scheduler 152 or the dynamic scheduler 156.

The GDC 1240 controls a display device 1245 and provides graphical operations. It may be integrated inside the processor 1210. It typically has a graphical user interface (GUI) to allow interactions with a user who may send a command or activate a function.

Additional devices or bus interfaces may be available for interconnections and/or expansion. The bus interfaces may be serial or parallel, with or without power delivery, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a query storage circuit to store query information related to at least one query from a host in a query property table;
a generator and allocator circuit configured to generate graph information using a batch of at least one vertex corresponding to the at least one query from the query property table and to allocate the at least one query to at least one logic unit (LU) based on the graph information; and
a search circuit having the at least one LU and configured to compute at least one distance, using the graph information, between the at least one vertex and at least one candidate neighbor of the at least one vertex to generate at least one distance result,
wherein the query property table is modified based on the at least one distance result.

2. The apparatus of claim 1, wherein the graph information includes at least one of a query identifier, a query vector, a neighbor identifier corresponding to the query identifier, a logic unit identifier associated with the query identifier, and a pre-fetched query and logic unit.

3. The apparatus of claim 1, wherein the generator and allocator circuit comprises:
a generator circuit to generate the graph information in a fetch pipeline;
a generator buffer configured to store the graph information; and
an allocator circuit configured to allocate the at least one query to the at least one LU.

4. The apparatus of claim 3, wherein the allocator circuit comprises:
a dispatcher configured to format the graph information from the generator buffer to generate formatted graph information;
an allocator buffer configured to store the formatted graph information identified by the logic unit identifier; and
an allocator controller configured to generate allocator data including at least one address of at least one neighbor and corresponding content to the at least one LU.

5. The apparatus of claim 4, wherein the search circuit comprises:
a storage array configured to store the allocator data in the format including at least one of a vertex array, an offset array, a neighbor array, a logic unit array, and a block array; and
a computing array having at least one LU, organized to correspond to the storage array, and configured to compute a current distance in a current iteration using the allocator data to generate at least one distance result, the at least one distance result being used to modify the query property table.

6. The apparatus of claim 5, wherein the computing array computes the current distance with the allocator circuit allocating the at least one query to the at least one LU.

7. The apparatus of claim 1, wherein the batch of at least one vertex is obtained by reordering an original graph having at least one original vertex using a reordering procedure that is based on vertex degree in an ascending order.

8. The apparatus of claim 7, wherein the vertex degree is based on number of neighbors of the vertex.

9. The apparatus of claim 1, wherein the reordering procedure is performed on the at least one original vertex in the at least one LU using a logic operation across at least one plane to utilize spatial locality.

10. The apparatus of claim 4 further comprising:
a sort circuit configured to sort the at least one distance in the at least one distance result and send at least one highest ranking candidate neighbor to the host.

11. A method comprising:
storing, in a query property table, query information related to at least one query from a host, the query information being represented in a format;
generating graph information using a batch of at least one vertex corresponding to the at least one query from the query property table;
allocating the at least one query to at least one logic unit (LU) based on the graph information;
computing at least one distance, using the graph information, between the at least one vertex and at least one candidate neighbor of the at least one vertex to generate at least one distance result; and
modifying the query property table based on the at least one distance result.

12. The method of claim 11, wherein the graph information includes at least one of a query identifier, a query vector, a neighbor identifier corresponding to the query identifier, a logic unit identifier associated with the query identifier, and a pre-fetched query and logic unit.

13. The method of claim 11, wherein generating graph information comprises:
generating the graph information in a fetch pipeline; and
storing the graph information in a generator buffer.

14. The method of claim 13, wherein allocating the at least one query comprises:
formatting the graph information from the generator buffer to generate formatted graph information;
storing the formatted graph information in an allocator buffer, the formatted graph information being identified by the logic unit identifier; and
generating allocator data including at least one address of at least one neighbor and corresponding content to the at least one LU.

15. The method of claim 14, wherein computing the at least one distance comprises:
storing the allocator data in the format including at least one of a vertex array, an offset array, a neighbor array, a logic unit array, and a block array; and
computing a current distance in a current iteration using the allocator data to generate at least one distance result, the at least one distance result being used to modify the query property table.

16. The method of claim 15, wherein computing the current distance comprises computing the current distance with allocating the at least one query to the at least one LU.

17. The method of claim 11, wherein the batch of at least one vertex is obtained by reordering an original graph having at least one original vertex using a reordering procedure that is based on vertex degree in an ascending order.

18. The method of claim 17, wherein the vertex degree is based on number of neighbors of the vertex.

19. The method of claim 11, wherein the reordering procedure is performed on the at least one original vertex in the at least one LU using a logic operation across at least one plane to utilize spatial locality.

20. A system comprising:
a static scheduler configured to reorder an original graph having at least one original vertex to generate a batch of at least one vertex using a reordering procedure that is based on vertex degree in an ascending order; and
a dynamic scheduler configured to compute at least one distance in the batch of the at least one vertex, the dynamic scheduler comprising:
a query storage circuit to store query information related to at least one query from a host in a query property table, the query information being represented in a format;
a generator and allocator circuit configured to generate graph information using the batch of the at least one vertex corresponding to the at least one query from the query property table and to allocate the at least one query to at least one logic unit (LU) based on the graph information;
a search circuit having the at least one LU and configured to compute the at least one distance, using the graph information, between the at least one vertex and at least one candidate neighbor of the at least one vertex to generate at least one distance result,
wherein the query property table is modified based on the at least one distance result; and
a sort circuit configured to sort the at least one distance in the at least one distance result and send at least one candidate neighbor corresponding to at least one highest ranking distance to the host.
